(19) United States
(12) Patent Application Publication
(10) Pub. No.: US 2013/0155487 A1
(43) Pub. Date: Jun. 20, 2013

(54) LIGHT MODULATOR PIXEL UNIT AND MANUFACTURING METHOD THEREOF

(71) Applicants: Jianhong Mao, Shanghai (CN); Deming Tang, Shanghai (CN); Fengqin Han, Shanghai (CN)

(72) Inventors: Jianhong Mao, Shanghai (CN); Deming Tang, Shanghai (CN); Fengqin Han, Shanghai (CN)

(73) Assignee: Lexvu Opto Microelectronics Technology (Shanghai) Ltd, Shanghai (CN)

(21) Appl. No.: 13/816,031

(22) PCT Filed: Jan. 26, 2011
(86) PCT No.: PCT/CN11/70651

§ 371 Date: Feb. 8, 2013

(30) Foreign Application Priority Data
Sep. 7, 2010 (CN) 201010278697.0

(51) Int. Cl. G02B 26/00

(52) U.S. Cl. CPC G02B 26/001
USPC 359/290

(57) ABSTRACT

A light modulator pixel unit and the manufacturing method thereof are provided. The pixel unit includes a top electrode formed on a substrate, a movable electrode and a bottom electrode. Under the control of a control circuit, the position of the movable electrode would deflect. When the movable electrode is positioned in a first position, a first light is diffracted on the top electrode; when the movable electrode is positioned in a second position, a second light is diffracted on the top electrode; when the movable electrode is positioned in a third position, a third light is diffracted on the top electrode. The said first light, second light and third light are lights of three primary colors. The light modulator pixel unit of the present invention can modulate lights of three colors and is applicable in the field of micro-display system.

### CROSS REFERENCE TO RELATED APPLICATIONS

The present application claims priority to Chinese Patent Application No. 201010278697.0, filed on Sep. 7, 2010 and entitled “Light Modulator Pixel Unit and Manufacturing Method thereof”, the entire disclosure of which is incorporated herein by reference.

### FIELD OF THE DISCLOSURE

The present disclosure generally relates to light modulators, and more particularly, to a light modulator pixel unit applied in a micro display system and a manufacturing method thereof.

### BACKGROUND OF THE DISCLOSURE

In projection systems, light modulators play an important role. A conventional light modulator generally includes a micro-electro-mechanical-systems (MEMS) unit which is controlled to move by electrical signals from the light modulator. And thereby lights coming into the light modulator are modulated to output lights with a specific gray scale.

A light modulator generally includes multiple pixel units arranged in a matrix. There are two kinds of pixel units in the conventional light modulator: a digital mirror device (DMD) based on the optical reflection principle and a grating light valve (GLV) based on the optical diffraction principle, among which, a single pixel of DMD having high energy consumption may result in a high consumption in whole, especially applying to a micro display system with a high resolution, while GLV has low energy consumption in whole due to the low energy cost of a single pixel, and further has virtues of good analog gray scales, high optical efficiency and modulating speed. So GLV becomes the mainstream technology.

A conventional light modulator pixel unit based on GLV technique is disclosed in a patent application with an international application number PCT/US2002/009602. Referring to FIG. 1, a GLV 100 includes: a semiconductor substrate 101; a reflecting layer 102 above the semiconductor substrate 101, the reflecting layer 102 including metal and having a first reflecting surface 103 away from the semiconductor substrate 101; a transparent insulating layer 107 above the first reflecting surface 103; at least one reflecting bar 104 above the first reflecting surface 103 and the transparent insulating layer 107, wherein there is an interval between the reflecting bar 104 and the first reflecting surface 103, and the reflecting bar 104 has a second reflecting surface 106 and includes metal; and at least one opening 105 between each two adjacent reflecting bars 104, so that lights may pass through the opening 105 to be incident on the first reflecting surface 103.

When an electrostatic force is exerted between the reflecting bar 104 and the reflecting layer 102, the reflecting bar 104 shifts to come into contact with the transparent insulating layer 107. A shifting distance of the reflecting bar 104 is determined by a thickness of the transparent insulating layer 107. After the electrostatic force is switched off, the reflecting bar 104 comes back to a previous location (a location before shifting).

With taking a light to be modulated with a wavelength λ as an example, the working principle of a conventional GLV is described as follows: the reflecting bar 104 shifts to the semiconductor substrate 101 under influence of the electrostatic force, and the shifting distance of the reflecting bar 104 is odd number times of λ/4, so that the incident light is diffracted on surfaces of the GLV. Specifically, the incident light is separated into a first part and a second part on surfaces of the GLV 100. The first part is reflected by the second reflecting surface 106; the second part passes through the opening 105, and is incident on and reflected by the first reflecting surface 103. Then the reflected second part is diffracted on the reflecting bar 104, and transmits upward around the reflecting bar 104. Because the second part which is reflected by the first reflecting surface 103 has a same frequency as the first part, and a wavelength difference between the first and second part is odd number times of λ/2, the first and second parts are superimposed above the reflecting bar 104 to form alternate bright and dark stripes. Then, a filter is used to filter the stripes, so as to obtain zero or first order light and output the zero or first order light. After switching off the electrostatic force, the reflecting bar 104 comes back to the previous location, the incident light on the surfaces of the GLV is still separated into a first part and a second part: the first part is reflected by the second reflecting surface 106; the second part passes through the opening 105, are incident on the first reflecting surface 103, and reflected by the first reflecting surface 103. The reflected second part is diffracted on the reflecting bar 104, and transmits upward around the reflecting bar 104. Here, the first and second parts are output together.

In light of the above, in the conventional art, as for the light to be modulated with a specific wavelength, the shifting distance of the GLV's reflecting bar 104 is configured according to, the thickness of the transparent insulating layer 107. Specifically, after the thickness of the transparent insulating layer 107 is determined, the shifting distance of the GLV's reflecting bar 104 is also determined, and the GLV can only modulate lights with a specific wavelength. In other words, the GLV can not modulate lights having other wavelengths, because the conventional GLV configures the shifting distance of the GLV's reflecting bar 104 according to the specific wavelength of the lights to be modulated rather than the magnitude of the electrostatic force, and only can modulate one kind of lights with the specific wavelength. Namely, the GLV only can modulate lights having one color. In a color display system (for forming color pixels), at least three GLVs need to work together. A first one is adapted for modulating red lights, a second one is adapted for modulating blue lights, and a third one is adapted for modulating green lights. The three GLVs work successively under control of a control circuit and respectively output lights with specific gray scales (including red, blue and green lights). To make sure color pixels seen by a user have contrast ratios, lights output by the GLVs need be filtered by a filter so that only zero or first order lights can arrive at visual systems of the user. The filtered lights constitute color pixels in the visual systems of the user.

The conventional light modulator needs three GLVs to form a color pixel, so it has a great device size, which is not applicable for a micro display system. Therefore, there is a need to provide a new light modulator to meet requirements of the micro display system.

### BRIEF SUMMARY OF THE DISCLOSURE

In the present disclosure, it is desire to provide an optical modulation pixel unit to modulate red, green and blue lights in one device with meeting requirements of a micro display system.

To solve the above problem, an embodiment of the present disclosure provides an optical modulation pixel unit, including:
a substrate;
a bottom electrode, being electrically connected with a first control end of a control circuit;
a top electrode formed on the substrate, being electrically connected with a third control end of the control circuit, wherein the top electrode is a grating including at least two grating bars and grating openings between each two adjacent grating bars, and surfaces of the grating bars far away from a top surface of the bottom electrode are reflecting surfaces; and
a movable electrode, located between the bottom electrode and the top electrode, wherein the movable electrode is electrically connected with a second control end of the control circuit, a surface of the movable electrode facing the top electrode is a reflecting surface, the movable electrode can move along a direction perpendicular to the reflecting surface, and an electrical insulating material is filled between the movable electrode and the top electrode and between the movable electrode and the bottom electrode.

There is a positional correspondence among the movable electrode, the top electrode, and the bottom electrode, an area of the movable electrode is less than that of the top electrode.

Under control of the control circuit, the movable electrode shifts to first, second and third positions, if the movable electrode shifts to the first position, a first light incident in the light modulator pixel unit passes through the grating openings of the top electrode, and is reflected by the movable electrode and diffracted on the top electrode; if the movable electrode shifts to the second position, a second light incident in the light modulator pixel unit passes through the grating openings of the top electrode, and is reflected by the movable electrode and diffracted on the top electrode; if the movable electrode shifts to the third position, a third light incident in the light modulator pixel unit passes through the grating openings of the top electrode, and is reflected by the movable electrode and diffracted on the top electrode, and the first, second and third lights are lights in three primary colors.

The grating bars and the grating opening have a same width ranging from about 0.1 μm to about 5 μm.

Optionally, the control circuit is located in the substrate, or formed in another substrate.

Optionally, the bottom and top electrode are electrically insulated from the substrate.

Optionally, the light modulator pixel unit further includes:
an interlayer dielectric layer, located on the substrate; and
a cavity, located in the interlayer dielectric layer, wherein the cavity has walls, the cavity is separated into a first part and a second part, the first part is a lower part of the cavity, and the second part is an upper part of the cavity,
wherein the bottom electrode is located in a part of the interlayer dielectric layer which is between the first part and the substrate, the top electrode is located in another part of the interlayer dielectric layer which is between the second part and the substrate, the movable electrode is located in the cavity, there is an interval between the movable electrode and the walls of the cavity, and the movable electrode can move in the interval.

Optionally, the electrical insulating material filled between the movable electrode and the top electrode and the electrical-insulating material filled between the movable electrode and the bottom electrode are the interlayer dielectric layer or formed by an additional process.

Optionally, the interlayer dielectric layer or the electrical insulating material formed by an additional process includes one selected from silicon oxide, silicon oxide nitride, silicon carbide, and silicon nitride, or a combination thereof.

Optionally, a plurality of second conducting plugs are formed in the interlayer dielectric layer and electrically connects the second control end with the movable electrode, wherein a distribution of the plurality of second conducting plugs is symmetrical and centered in a center of the movable electrode.

Optionally, the top electrode includes metal and have a thickness ranging from about 500 Å to about 10000 Å, wherein the metal includes one selected from silver, aluminum, copper, titanium, platinum, gold, nickel, and cobalt, or a combination thereof.

Optionally, the movable electrode includes metal and have a thickness ranging from about 500 Å to about 10000 Å, wherein the metal includes one selected from silver, aluminum, copper, titanium, platinum, gold, nickel, and cobalt, or a combination thereof.

Optionally, the grating bars and the movable electrode have a same material.

Another embodiment of the present disclosure further provides a method for manufacturing an light modulator pixel unit, including:
providing a substrate;
forming a bottom electrode on the substrate, wherein the bottom electrode is electrically connected with a first control end of a control circuit;
forming a top electrode on the substrate, wherein the top electrode is electrically connected with a third control end of the control circuit, the top electrode is a grating including at least two grating bars and at least one grating opening between each two adjacent grating bars, and surfaces of the grating bars far away from the bottom electrode are reflecting surfaces; and
forming movable electrode. Wherein the movable electrode is located between the bottom electrode and the top electrode, the movable electrode is electrically connected with a second control end of the control circuit, there is an electrical insulating materials formed between the movable electrode and the top electrode or between the movable electrode and the bottom electrode, a surface of the movable electrode facing the top electrode is a reflecting surface.

The movable electrode shifts to a first, second and third position, along a direction perpendicular to the reflecting surface: if the movable electrode shifts to the first position, a first light incident in the light modulator pixel unit passes through the grating openings of the top electrode, and is reflected by the movable electrode and diffracted on the top electrode; if the movable electrode shifts to the second position, a second light incident in the light modulator pixel unit passes through the grating openings of the top electrode, and is reflected by the movable electrode and diffracted on the top electrode; if the movable electrode shifts to the third position, a third light incident in the light modulator pixel unit passes through the grating openings of the top electrode, and is reflected by the movable electrode and diffracted on the top electrode, and the first, second and third lights are lights in three primary colors, and the grating bars and the grating openings have a same width.

Optionally, the control circuit is located in the substrate, or formed in another substrate.

Optionally, the bottom and top electrode are electrically insulated from the substrate.

Optionally, the method further includes:
forming an interlayer dielectric layer;
forming a cavity in the interlayer dielectric layer, wherein the cavity includes walls, the cavity includes a first part and second part, the first part is located in lower part of the cavity, and the second part is located in upper part of the cavity. The bottom electrode is in a part of the interlayer dielectric layer which is between the first part and the substrate. The top electrode is another part of the interlayer dielectric layer which is between the second part and the substrate. The movable electrode is in the cavity, there are an interval between the movable electrode and the walls of the cavity, and the movable electrode can move in the interval.

Optionally, the electrical insulating material filled between the movable electrode and the top electrode and the electrical insulating material filled between the movable electrode and the bottom electrode are the interlayer dielectric layer or formed by an additional process.

Optionally, a plurality of second conducting plugs are formed in the interlayer dielectric layer and electrically connect the second control end with the movable electrode, wherein the multiple second conducting plugs are symmetrically distributed with respect to the center of the movable electrode.

Optionally, the grating bars and the movable electrode have a same material.

Compared with the prior art, the embodiments of the present disclosure have the following advantages.

The optical modulation pixel unit includes the bottom and top electrodes on the substrate and the movable electrode between the bottom and top electrodes. The movable electrode has a reflecting surface and moves along a direction perpendicular to the reflecting surface. In the embodiments of the present disclosure, the movable electrode shifts between the bottom and top electrode and can be in a first, second and third position: if the movable electrode shifts to the first position, a first light incident in the light modulator pixel unit passes through the grating openings of the top electrode, and is reflected by the movable electrode and diffracted on the top electrode; if the movable electrode shifts to the second position, a second light incident in the light modulator pixel unit passes through the grating openings of the top electrode, and is reflected by the movable electrode and diffracted on the top electrode; if the movable electrode shifts to the third position, a third light incident in the light modulator pixel unit passes through the grating openings of the top electrode, and is reflected by the movable electrode and diffracted on the top electrode, and the first, second and third lights are lights in three primary colors, and the grating bars and the grating opening have a same width. The optical modulation pixel unit can modulate lights in three primary colors and is applicable to the micro display system.

### BRIEF DESCRIPTION OF THE DRAWINGS

In order to clearly clarify the objects, characteristics and advantages of the present disclosure, specific embodiments and examples are described herein in conjunction with the attached drawings. It should be noted that, in the accompanying drawings, for convenience of description, the sizes of respective components may not be drawn based on actual scales. Also, the same or similar reference signs represent the same or similar components in the accompanying drawings.

FIG. 1 is a structural schematic view of a conventional grating light valve;

FIG. 2 is a structural schematic view of an optical modulator pixel unit in an embodiment of the present disclosure;

FIG. 3 is a schematic sectional view of FIG. 2 along an AA direction;

FIG. 4 is a schematic sectional view of FIG. 2 along a BB direction;

FIG. 5 is a sequence chart of an input light and an output light of an optical modulator pixel unit in an embodiment of the present disclosure;

FIG. 6 is a flow chart to illustrate a method for manufacturing an optical modulator pixel unit in an embodiment of the present disclosure;

FIGS. 7 to 14 are intermediate structural schematic views to illustrate a method for manufacturing an optical modulator pixel unit in an embodiment of the present disclosure; and

FIG. 15 is a schematic sectional view of FIG. 10 along an AA direction.

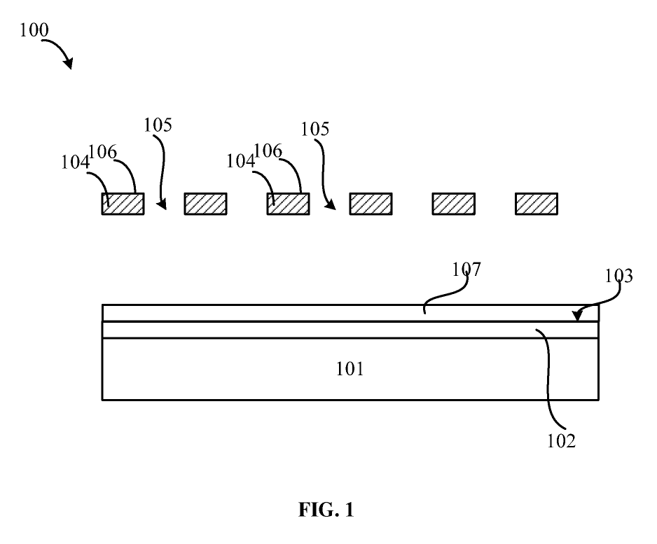

### DETAILED DESCRIPTION OF THE DISCLOSURE

In the conventional art, three GLVs need to work together to form a color pixel, and the three GLVs are respectively adapted for modulating red, green and blue lights, which may cause large device area and high product cost. Therefore, the solution in the conventional art is not applicable for a micro display system.

To solve the above problems, a light modulator pixel unit is provided in embodiments of the present disclosure to modulate lights based on diffraction theory. According to the embodiments, only one light modulator pixel unit is needed to modulate lights in three colors, which has the advantages of reduced device area and low product cost, and can be applied to a micro display system. Moreover, the light modulator pixel unit has a high utilization ratio of light, so that low energy consumption can be achieved for each pixel or the whole light modulator pixel unit.

A structure of the light modulator pixel unit is described in detail hereinafter.

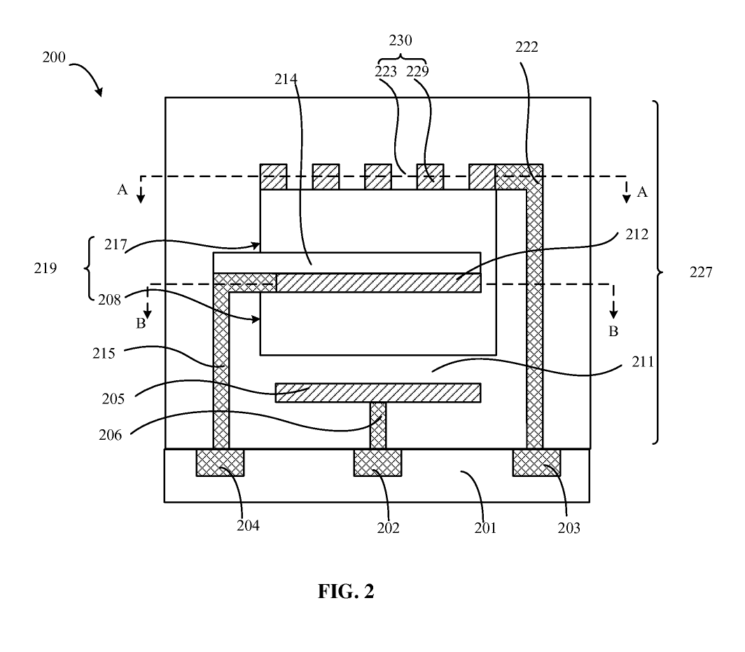

FIG. 2 is a structural schematic view of a light modulator pixel unit in an embodiment of the present disclosure. Referring to FIG. 2, the light modulator pixel unit includes: a substrate 201; a bottom electrode 205, being electrically connected with a first control end 206 of a control circuit; a top electrode 230, formed on the substrate 201, and being electrically connected with a third control end 222 of the control circuit, wherein the top electrode 203 is a grating including at least two grating bars 229 and at least one grating opening 223 between each two adjacent grating bars 229, and surfaces of the grating bars 229 far away from a top surface the bottom electrode 205 are reflecting surfaces; a movable electrode 212, located between the bottom electrode 205 and the top electrode 230, wherein the bottom electrode 205 is electrically connected with a second control end 215 of the control circuit, a surface of the movable electrode 212 facing the top electrode 230 is a reflecting surface, the movable electrode 212 can move along a direction perpendicular to the reflecting surface, and an insulating material is filled between the movable electrode 212 and the top electrode 230 and between the movable electrode 212 and the bottom electrode 205.

There is a positional correspondence among the movable electrode 212, the top electrode 230, and the bottom electrode 205. An area of the movable electrode 212 is less than that of the top electrode 230. Under control of the control circuit, the movable electrode 212 shifts to a first, second and third position. When the movable electrode 212 shifts to the first position, a first light incident in the light modulator pixel unit passes through the grating openings 223 of the top electrode 230, and is reflected by the movable electrode 212 and diffracted on the top electrode 230. When the movable electrode 212 shifts to the second position, a second light incident in the light modulator pixel unit passes through the grating openings 223 of the top electrode 230, and is reflected by the movable electrode 212 and diffracted on the top electrode 230. When the movable electrode 212 shifts to the third position, a third light incident in the light modulator pixel unit passes through the grating openings 223 of the top electrode 230, and is reflected by the movable electrode 212 and diffracted on the top electrode 230. The first, second and third lights are in three primary colors. The grating bars 229 and the grating openings 223 have a same width ranging from about 0.1 μm to about 5 μm.

Specifically, in an embodiment, the substrate 201 is a semiconductor substrate, including silicon, germanium, gallium arsenide or the like. In other embodiments, the substrate 201 may be a glass substrate. In the following description, a semiconductor substrate is taken as an example for illustration.

The control circuit is adapted for exerting control signals to each element on the substrate 201 (such as the movable electrode 212, the top electrode 230, and the bottom electrode 205). The control circuit includes the first, second and third control ends 202, 204, and 203. The control circuit may be formed in the substrate 201 (if the substrate 201 is a semiconductor substrate), or in another semiconductor substrate and electrically connected with elements on the substrate 201 through conducting elements.

Referring to FIG. 2, the light modulator pixel unit 200 further includes: an interlayer dielectric layer 227, located on the substrate 201; and a cavity 219, located in the interlayer dielectric layer 227, having walls, and being separated into a first part 208 and a second part 217, wherein the first part 208 is a lower part of the cavity 219, and the second part 209 is an upper part of the cavity 219. The bottom electrode 205 is located in a part of the interlayer dielectric layer 227 which is between the first part 208 and the substrate 201. The top electrode 230 is located in a part of the interlayer dielectric layer 227 which is between the second part 217 and the substrate 201. The movable electrode 212 is located in the cavity 219. There is an interval between the movable electrode 212 and the walls of the cavity 219, and the movable electrode 212 can move in the interval.

The movable electrode 212 is located between the bottom electrode 205 and the top electrode 230 and is electrically connected with the second control end 204. A surface of the movable electrode 212 facing the top electrode 230 is a reflecting surface, and the movable electrode 212 can move along a direction perpendicular to the reflecting surface. An insulating material is filled between the movable electrode 212 and the top electrode 230 and between the movable electrode 212 and the bottom electrode 205. It should be noted that, in the embodiments of the present disclosure, incoming parallel light reflected from the reflecting surfaces are reflected parallel lights (namely, reflections happening on the reflecting surfaces are specular reflections).

In an embodiment, the movable electrode 212 is located in the cavity 219. There is an interval between the movable electrode 212 and the walls of the cavity 219, and the movable electrode 212 can move in the interval. The movable electrode 212 is electrically connected with the second control end 204, a surface of the movable electrode 212 facing the top electrode 230 is a reflecting surface, and the movable electrode 212 may move along a direction perpendicular to the reflecting surface.

The light modulator pixel unit 200 further includes a top insulating layer 214 located between the movable electrode 212 and the top electrode 230, which is adapted for insulating the movable electrode 212 from the top electrode 230. In an embodiment, the top insulating layer 214 may be a part of the interlayer dielectric layer 227. In other embodiments, the top insulating layer 214 may be formed by filling an additional insulating material between the movable electrode 212 and the top electrode 230, and adapted for electrically insulating the movable electrode 212 from the top electrode 230.

The light modulator pixel unit 200 further includes a bottom insulating layer 211 located between the movable electrode 212 and the bottom electrode 205. In an embodiment, the bottom insulating layer 211 may be a part of the interlayer dielectric layer 227. In other embodiments, the bottom insulating layer 211 may be formed by filling an additional insulating material between the movable electrode 212 and the bottom electrode 205, and adapted for electrically insulating the movable electrode 212 from the bottom electrode 205.

There is a positional correspondence among the movable electrode 212, the top electrode 230, and the bottom electrode 205. An area of the movable electrode 212 is less than that of the top electrode 230. Under control of the control circuit, the movable electrode 212 may shift to first, second and third positions. If the movable electrode 212 shifts to the first position, a first light incident in the light modulator pixel unit passes through the grating openings 223 of the top electrode 230. and is reflected by the movable electrode 212 and diffracted on the top electrode 230; If the movable electrode 212 shifts to the second position, a second light incident in the light modulator pixel unit passes through the grating openings 223 of the top electrode 230, and is reflected by the movable electrode 212 and diffracted on the top electrode 230; If the movable electrode 212 shifts to the third position, there is no interval but the bottom insulating layer 211 between the movable electrode 212 and the top electrode 221, and a third light incident in the light modulator pixel unit passes through the grating openings 223 of the top electrode 230, and is reflected by the movable electrode 212 and diffracted on the top electrode 230.

The first, second and third lights are lights in three primary colors. The first, second and third lights are respectively a blue light, a green light and a red light. In a preferable embodiment, wavelengths of the first, second the third lights can be selected for ensuring the light modulator pixel unit has a good sensitivity to lights and a good modulation performance. For example, the first light is a blue light with a wavelength ranging from about 465 nm to about 480 nm, the second light is a green light with a wavelength ranging from about 525 nm to about 540 nm, and the third light is a red light with a wavelength ranging from about 675 nm to about 695 nm. As long as the first, second and third lights are three primary lights and each of them has a single wavelength (has a single color), the first, second and third lights may be lights with other wavelengths, which is not described in detail herein.

Referring to FIG. 2, there is a positional correspondence among the cavity 219, the bottom electrode 205, and the top electrode 230. The cavity 219 has a width greater than that of the bottom electrode 205, and has a size and shape corresponding to those of the movable electrode 212. There is an interval between the movable electrode 212 and the walls of the cavity 219, and the movable electrode 212 can move in the interval. The size and shape of the cavity can be determined according to practical requirements.

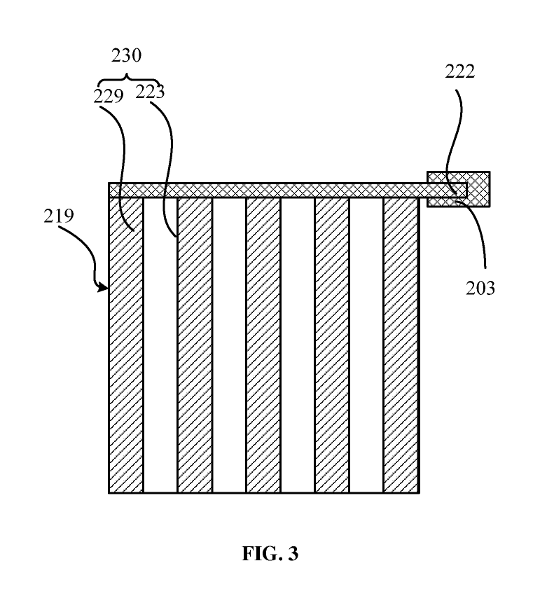

There are multiple second conducting plugs 215 formed in the interlayer dielectric layer 227. The second conducting plug 215 electrically connects the second control end 204 with the movable electrode 212. The multiple second conducting plugs 215 are symmetrically distributed with respect to the center of the movable electrode 212. In an embodiment, the number of the second conducting plugs 215 is two. But in FIG. 2, only one second conducting plug 215 is shown. In FIG. 3, the relationship among the second conducting plugs 215, the movable electrode 212 and the cavity 219 will be described later.

A first conducting plug 206 and a third conducting plug 222 are formed in the interlayer dielectric layer 227. The first conducting plug 206 is adapted for electrically connecting the first control end 206 with the bottom electrode 205, and the third conducting plug 206 is adapted for electrically connecting the third control end 203 with the grating bars 229 of the top electrode 230.

Further, the top electrode 230 is adapted for light splitting, namely splitting light incident from the top electrode 230 into two parts. The top electrode 230 is a grating, including multiple grating bars 229 and grating openings between each two adjacent grating bars 229. A width of the grating openings is from about 0.1 μm to about 5 μm. The grating bars 229 include metal which may be one selected from silver, aluminum, copper, titanium, platinum, gold, nickel and cobalt, or a combination thereof. A thickness of the grating bars 229 ranges from about 500 Å to about 10000 Å.

Because the top electrode 230 is located in the interlayer dielectric layer 227, and surfaces of the grating bars 229 far away from the bottom electrode 205 are reflecting surfaces, the light incident from the top electrode 230 are splited into a first part and a second part by the grating bars 229 and grating openings 223 of the top electrode 230. The first part of light are reflected on the reflecting surfaces of the top electrode 230's grating bars 229, the second part of light passes through the grating openings 223 and are incident on the movable electrode 212.

In an embodiment, the grating bars 229 and the grating openings 223 of the top electrode 230 have a same width, so that the first part of light reflected by the grating bars 229 has a same intensity as that of the second part of light passing through the grating openings 223.

After the second part of light passes through the grating opening 223 and are incident on a reflecting surface of the movable electrode 212, the second parts of light is reflected by the reflecting surface of the movable electrode 212 to the bottom surfaces of the grating bars 229. Because the width of the grating openings 223 is less than the wavelength of the light (the first, second or third light), the second part of light is diffracted on the grating bars 229 and transmits upward above the grating bars 229, and is superimposed to the first part on the top electrode 230 to form bright and dark stripes.

In an embodiment, the movable electrode 212 includes metal which may be one selected from silver, aluminum, copper, titanium, platinum, gold, nickel and cobalt, or a combination thereof. A thickness of the movable electrode 212 ranges from about 500 Å to about 10000 Å.

In an embodiment, the top insulating layer 214 may be formed between the movable electrode 212 and the top electrode 230 and above the reflecting surface of the movable electrode 212, and may be an additional electrical insulating layer and include one selected from silicon oxide, silicon oxide nitride, silicon carbide and silicon nitride, or a combination thereof.

In an embodiment, the top insulating layer 214 shifts as the movable electrode 212 moves along a direction perpendicular to its reflecting surface in the cavity 219. Because the movable electrode 223 includes metal which may have uneven thickness due to process limitations in manufacturing processes, and metal fatigue may happen therein due to frequent shifting of the movable electrode 212, the top insulating layer 214 is formed above the top electrode 212, which can greatly improve resistance to bending fatigue of the movable electrode 212.

Therefore, while the movable electrode 212 shifting in the cavity 219, the top insulating layer 214 formed above the top electrode 212 also shifts with the movable electrode 212. Besides, because the top insulating layer 214 is transparent, light can pass through the top insulating layer 214, arrive at the movable electrode 212 and be reflected on the surface of the movable electrode 212.

In other embodiments, the resistance to bending fatigue of the movable electrode 212 may be improved by optimizing manufacturing process or selecting appropriate materials, thus the top insulating layer 214 above the reflecting surface of the movable electrode 212 is not needed. In such a case, the top insulating layer 214 may be formed above the second part of the cavity 219, which may be a part of the interlayer dielectric layer 227 or an additional electrical insulating layer including one selected from silicon oxide, silicon oxide nitride, silicon carbide and silicon nitride, or a combination thereof.

There is a relationship between a thickness of the top insulating layer 214 and a wavelength of incident light to be modulated, and the thickness of the top insulating layer 214 can be determined according to the wavelength of incident light to be modulated. In an embodiment, when the movable electrode 212 moves to the first position, the thickness of the top insulating layer 214 needs to ensure that a distance between the reflecting surface of the movable electrode 212 and the top electrode 230 is odd number times of ¼ of the wavelength of the first light. Because when the movable electrode 212 is in the first position, there is no interval between the movable electrode 212 and the top electrode 230, but only the top insulating layer 214, summation of the thickness of the top insulating layer 214 and the thickness of the top electrode 230 should be equal to odd number times of ¼ of the wavelength of the first light.

The bottom insulating layer 211 formed between the movable electrode 211 and the bottom electrode 205 is adapted for electrically insulating the movable electrode 211 from the bottom electrode 205. In an embodiment, the bottom insulating layer 211 may be a part of the interlayer dielectric layer. In other embodiments, the bottom insulating layer 211 may be an additional electrical insulating layer and include one selected from silicon oxide, silicon oxide nitride, silicon carbide and silicon nitride, or a combination thereof.

For illustrating the structure of the light modulator pixel unit in the present disclosure more clearly, please refer to FIG. 3, a schematic sectional view of FIG. 2 along an A-A′ direction. The top electrode 230, the third conducting plug 222 and the third control end 203 are shown in FIG. 3. The top electrode 230 is located above the cavity 219, and includes multiple grating bars 229. There are five grating bars 229 shown in FIG. 3.

Between each two adjacent grating bars 229, there is a grating opening 223. The grating bars 229 and grating openings 223 have a same width. The width of a grating bar 229 is a distance between one side and the other side of the grating bar, and the width of a grating opening 229 is a distance from one side of a grating bar to a side of an adjacent grating bar. The grating bars 229 are electrically connected with the third control end 229 through the third conducting plug 222.

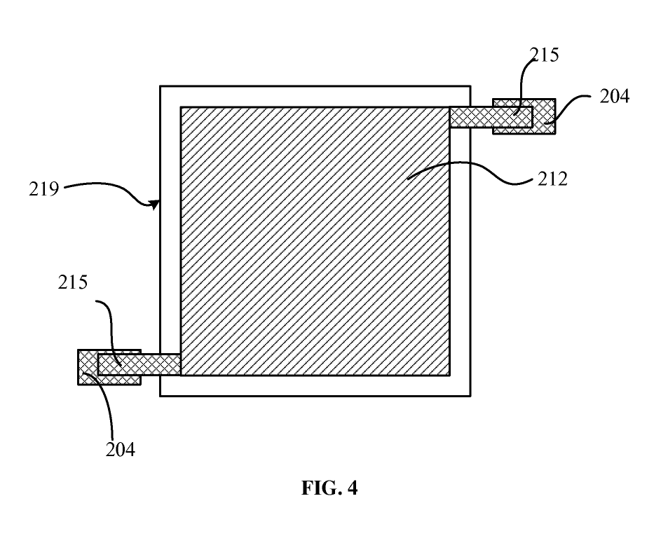

Referring to FIG. 4, a schematic sectional view of FIG. 2 along a BB direction. There is an interval between the movable electrode 212 and the walls of the cavity 219, and the movable electrode 212 can move in the interval. The movable electrode 212 is electrically connected with the second control end 204 through the multiple second conducting plugs 215, and the multiple second conducting plugs 215 are symmetrically distributed with respect to the center of the movable electrode 212. The second conducting plugs are not only adapted for electrically connecting the movable electrode 212 and the second control end 204, but also adapted for suspending the movable electrode 212 in the cavity 219 and supporting the movable electrode 212 to move. The number of the second conducting plugs 215 may be two or more than two. In the embodiment shown in FIG. 4, there are two second conducting plugs 215.

The working principle of the light modulator pixel unit in the embodiments of the present disclosure is described in detail as follows in conjunction with the attached drawings. It should be noted that, for forming color pixels, the light modulator pixel unit successively modulates the first, second and third lights. The first, second and third lights are respectively a blue, green and red light.

The first, second and third lights may come from three independent LED light sources, or be formed by performing filtering and color wheel processing to a light from a white light source, which is not described in detail herein. The first, second and third lights are successively input into the light modulator pixel unit, and each of which lasts for a period of time. For simple illustration, a time period for inputting the first light into the light modulator pixel unit is defined as a first light period, a time period for inputting the second light into the light modulator pixel unit is defined as a second light period, and a time period for inputting the third light into the light modulator pixel unit is defined as a third light period.

Referring to FIG. 2, the first, second and third control ends 202, 204, and 203 of the control circuit are respectively electrically connected with the bottom electrode 205, the movable electrode 212 and the top electrode 230.

Because the top insulating layer 214 is formed between the top electrode 230 and the movable electrode 212, the top electrode 230, top insulating layer 214 and the movable electrode 212 constitute a first capacitor structure. If the control circuit exerts an electrical signal between the second control end 202 and the third control end 203 (namely, the first capacitor structure is charged), a first electrostatic force is formed between the top electrode 230 and the movable electrode 212. The first electrostatic force makes the movable electrode 212 (including the top insulating layer 214 on the movable electrode 212) shift to the top electrode 230 (the second conducting plug 215 is electrically connected with the movable electrode 212 and elastic deformation happens to the second conducting plug 215), until the top insulating layer 214 comes into contact with the top electrode 230, where the movable electrode 212 is in the first position, and there is a first predetermined distance between the reflecting surface of the movable electrode 212 and the top electrode 230, which equals to odd number times of ¼ of the first light's wavelength. In such a case, if the first light is incident into the light modulator pixel unit, the incident first light passing through the top electrode 230 is separated to a first part and a second part, where the first part is reflected by the reflecting surfaces of the top electrode 230's grating bars 229, and the second part passes through the top electrode 230's grating openings 223, arrives at the reflecting surface of the movable electrode 212, is reflected to the top electrode 230's grating bars 229 by the reflecting surface of the movable electrode 212, and is diffracted on the grating bars 229 and transmits upward to form bright and dark stripes. The diffraction principle and the principle of forming the bright and dark stripes are the same as those of a conventional GLV, which is well known by those skilled in the art and not described in detail herein. In subsequence, a filter plate may be used to filter and output zero or first order light. The structure and working principle of the filter plate is the same as that in prior art, which is well known by those skilled in the art and not described in detail herein.

If there is no electrical signal exerted between the second and third control ends 202 and 203 or the electrical signal exerted between the second and third control end 202 and 203 is switched off, the first electrostatic force disappears and the second conducting plug 215 comes back to an original state before the elastic deformation, so that the movable electrode 212 shifts to the relaxed state under traction of the second conducting plug 215, where the movable electrode is in the second position, and there is a second predetermined distance between the reflecting surface of the movable electrode 212 and the top electrode 230, which equals to odd number times of ¼ of the second light's wavelength. In such a case, if the second light is incident into the light modulator pixel unit, the incident second light passing through the top electrode 230 is separated to a first part and a second part, the first part is reflected by reflecting surfaces of the top electrode 230's grating bars 229, and the second part passes through the top electrode 230's grating openings 223, arrives at the reflecting surface of the movable electrode 212, is reflected to the top electrode 230's grating bars 229 by the reflecting surface of the movable electrode 212, and is diffracted on the grating bars 229 and transmits upward. Because the second transmits upward above the grating bars 229, the second and first parts are superimposed together on the top electrode 230 to form bright and dark stripes. The diffraction principle and the principle of forming the bright and dark stripes are the same as those of the conventional GLV, which is well known by those skilled in the art and not described in detail herein. In sequence, a filter plate is used to filter and output zero or first order light. The structure and working principle of the filter plate is the same as that in prior art, which is well known by those skilled in the art and not described in detail herein.

The bottom insulating layer 211 is formed between the bottom electrode 205 and the movable electrode 212, and the bottom electrode 205, top insulating layer 211 and the movable electrode 212 constitute a second capacitor structure. If the control circuit exerts an electrical signal between the first control end 202 and the second control end 204 (the second capacitor structure is charging), so that a second electrostatic force is formed between the movable electrode 212 and the bottom electrode 205. The second electrostatic force makes the movable electrode 212 shift to the bottom electrode 205 (the second conducting plug 215 is electrically connected with the movable electrode 212 and elastic deformation happens to the second conducting plug 215), the movable electrode 212 moves to contact with the bottom of the cavity 219, the movable electrode 212 is in the third position, and there is a third predetermined distance between the reflecting surface of the movable electrode 212 and the top electrode 230, equal to odd number times of ¼ of the first light's wavelength. In such a case, if the third light is incident into the light modulator pixel unit, the incident third light passing through the top electrode 230 is separated to a first part and a second part, the first part is reflected by reflecting surfaces of the top electrode 230's grating bars 229, and the second part passes through the top electrode 230's grating openings 223, arrives at the reflecting surface of the movable electrode 212, is reflected to the top electrode 230's grating bars 229 by the reflecting surface of the movable electrode 212, and is diffracted on the grating bars 229 and transmits upward. Because the second is transmit upward above the grating bars 229, the second and first part are superimposed together on the top electrode 230 to form bright and dark stripes. The diffraction principle and the principle of forming the bright and dark stripes are the same as those of the conventional GLV, which is well known by those skilled in the art and not described in detail herein. In sequence, a filter plate is used to filter and output zero or first order lights. The structure and working principle of the filter plate is the same as that in prior art, which is well known by those skilled in the art and not described in detail herein.

In light of the foregoing, when a distance between the reflecting surface of the movable electrode 212 and the top electrode 230 is equal to odd number times of ¼ of the first light's wavelength, if the first light is input into the light modulator pixel unit, the bright and dark stripes are output. And after filtering the bright and dark stripes, zero or first order light corresponding to the first light can be obtained. If the second or third light is input into the light modulator pixel unit, the light modulator pixel unit works like a mirror, which reflects and outputs the second or third light.

Similarly, when a distance between the reflecting surface 213 of the movable electrode 212 and the top electrode 230 is equal to odd number times of ¼ of the second light's wavelength, if the second light is input into the light modulator pixel unit, the bright and dark stripes are output. And after filtering the bright and dark stripes, zero or first order lights corresponding to the second light can be obtained. And if the first or third light is input into the light modulator pixel unit and the light modulator pixel unit works like a mirror, which reflects and outputs the first or third light.

Similarly, when a distance between the reflecting surface of the movable electrode 212 and the top electrode 230 is equal to odd number times of ¼ of the third light's wavelength, if the third light is input into the light modulator pixel unit, the bright and dark stripes are output, and after filtering the bright and dark stripes, zero or one order lights corresponding to the third light can be obtained. And if the second or third light is input into the light modulator pixel unit and the light modulator pixel unit works like a mirror, which reflects and outputs the second or third light.

In conclusion, the light modulator pixel unit in embodiments of the present disclosure controls the distance between the reflecting surface of the movable electrode and the top electrode, so that the length of the first light period for outputting the bright and dark stripes corresponding to the first light can be controlled, thereby controlling a gray scale of the first light output by the light modulator pixel unit. The gray scales of the second and third lights output by the light modulator pixel unit can be controlled in the same way. When the first, second and third lights are successively output by the light modulator pixel unit and arrive at the visual system of a user, the first, second and third lights constitute a color pixel in the visual system of the user. It should be noted that, time intervals between outputting the first, second and third lights need be short enough so that the user feels the first, second and third lights arriving at the visual system at the same time, which is the same as the prior art and not described in detail herein.

A pulse-width modulation (PWM) technology is used to exert electrical signals to the bottom, movable and top electrodes. The first capacitor structure including the bottom and movable electrodes or the second capacitor structure including the top and movable electrodes is charged by using a high-level pulse signal, which is well know by those skilled in the art and not described in detail herein.

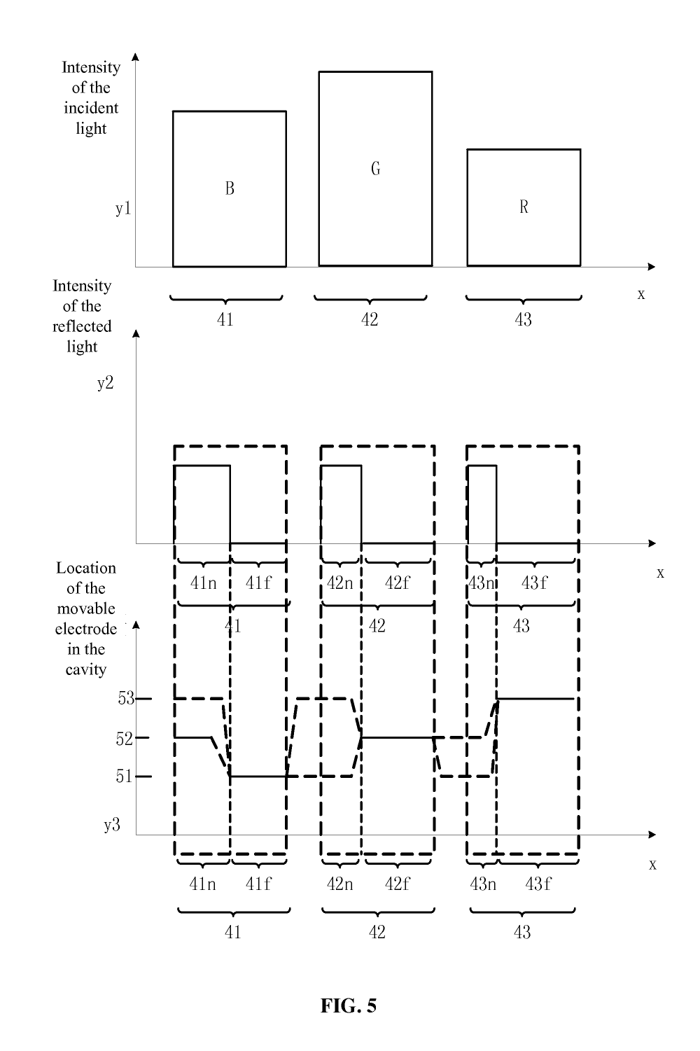

Referring to FIG. 5, a sequence chart for illustrating a light modulator pixel unit inputs and outputs light in an embodiment of the present disclosure. The x axis is a time axis, and the y1 axis shows intensities of incident lights. Red, green and blue lights, R, G, and B, are successively input into the light modulator pixel unit. In order to obtain a good display performance, among the incidents lights, the intensity of the green light is the greatest. For ease of brief illustration, a period of time for inputting the blue light is defined as a first light period 41, a period of time for inputting the green light is defined as a second light period 42, and a period of time for inputting the red light is defined as a third light period 43.

In FIG. 5, the y2 axis shows intensities of reflected lights, and the y3 axis shows a position in the cavity where the movable electrode is located. With taking the first light as an example, the first light period further includes a first on period 41n and a first off period 41f.

In the first on period 41n, the movable electrode is in a second position 52 or a third position 53 in the cavity, and the light modulator pixel unit outputs the first light. In the first off period 41f, the movable electrode is in a first position 51, and nothing is output by the light modulator pixel unit. By controlling a ratio between the first on period 41n and the first off period 41f, the gray scale of the first light output by the light modulator pixel unit can be controlled. Working principle of the second and third light periods 42 and 43, may be referred to the working principle of the first light period 41, which is not described in detail herein.

In the light modulator pixel unit, sizes of each element in the interlayer dielectric layer and sizes of the bottom, movable, and top electrodes and the cavity can be specifically determined according to the light to be modulated. A thickness of the top electrode is about 500 Å to about 10000 Å. A thickness of the movable electrode is about 500 Å to about 10000 Å. A thickness of the top insulating layer needs be determined to ensure that: the distance between the reflecting surface of the movable electrode and the top electrode is odd number times of ¼ of the first light's wavelength when the movable electrode moves to the first position; and the distance between the reflecting surface of the movable electrode and the top electrode is odd number times of ¼ of the second light's wavelength when the movable electrode moves to the second position. A depth of the cavity is configured to ensure that the distance between the reflecting surface of the movable electrode and the top electrode is odd number times of ¼ of the third light's wavelength when the movable electrode moves to the bottom electrode and arrives at the third position. Those skilled in the art may do calculation according to wavelengths of the lights to be modulated.

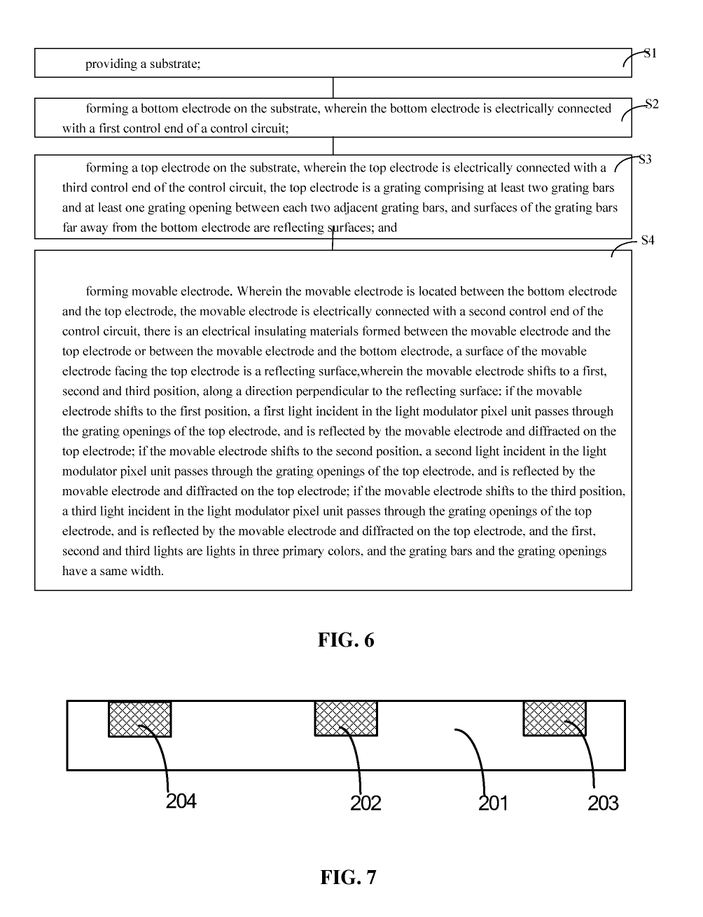

Another embodiment of the present disclosure further provides a method for manufacturing a light modulator pixel unit. Referring to FIG. 6, a flow chart of a method for manufacturing a light modulator pixel unit in an embodiment of the present disclosure. The method includes:

S1, providing a substrate;

S2, forming a bottom electrode on the substrate, where the bottom electrode is electrically connected with a first control end of a control circuit;

S3, forming a top electrode on the substrate, where the top electrode is electrically connected with a third control end of the control circuit, the top electrode is a grating including at least two grating bars and at least one grating opening between each two adjacent grating bars, and surfaces of the grating bars far away from the bottom electrode are reflecting surfaces;

S4, forming a movable electrode on the substrate. The movable electrode is located between the bottom electrode and the top electrode and is electrically connected with a second control end of the control circuit. There is an electrical insulating material formed between the movable electrode and the top electrode and between the movable electrode and the bottom electrode. A surface of the movable electrode facing the top electrode is a reflecting surface. The movable electrode may shift to a first, second or third position, along a direction perpendicular to the reflecting surface. Specifically, when the movable electrode shifts to the first position, a first light incident in the light modulator pixel unit passes through the grating openings of the top electrode, and is reflected by the movable electrode and diffracted on the top electrode; when the movable electrode shifts to the second position, a second light incident in the light modulator pixel unit passes through the grating openings of the top electrode, and is reflected by the movable electrode and diffracted on the top electrode; when the movable electrode shifts to the third position, a third light incident in the light modulator pixel unit passes through the grating openings of the top electrode, and is reflected by the movable electrode and diffracted on the top electrode. The first, second and third lights are lights in three primary colors, and the grating bars and the grating openings have a same width.

In another embodiment, the method further includes: forming an interlayer dielectric layer, and forming a cavity in the interlayer dielectric layer. The cavity includes walls, and is divided into a first part and a second part, where the first part is located in a lower part of the cavity, and the second part is located in an upper part of the cavity.

The bottom electrode is in a part of the interlayer dielectric layer which is between the first part of the cavity and the substrate.

The top electrode is in another part of the interlayer dielectric layer which is between the second part of the cavity and the substrate.

The movable electrode is in the cavity. There are an interval between the movable electrode and the walls of the cavity, and the movable electrode can move in the interval.

In an embodiment, the substrate is a semiconductor substrate, including silicon, germanium, gallium arsenide or the like. In other embodiments, the substrate 201 may be a glass substrate. In the following description, a semiconductor substrate is taken as an example for illustration.

The control circuit is adapted for exerting control signals to each element formed on the substrate. The control circuit is formed in the substrate or in another semiconductor substrate. In a preferable embodiment, the control circuit is formed in the substrate so that device area can be reduced, which is suitable for a micro display system.

A control circuit formed in the substrate is taken as an example in the following description, which is described hereinafter in detail in conjunction with attached drawings. FIGS. 7 to 14 are intermediate sectional views for illustrating a method for manufacturing a light modulator pixel unit in an embodiment of the present disclosure.

As shown in FIG. 7, a substrate 201 is formed, and the substrate 201 is a semiconductor substrate. A control circuit, which includes a first, second and third control ends 202, 204 and 203, is formed in the substrate 201. The first, second and third control ends 202, 204 and 203 are respectively adapted for exerting electrical signals to the bottom, movable and top electrodes, and are distributed corresponding to locations of the bottom, movable and top electrodes, which can be configured according to practical requirements.

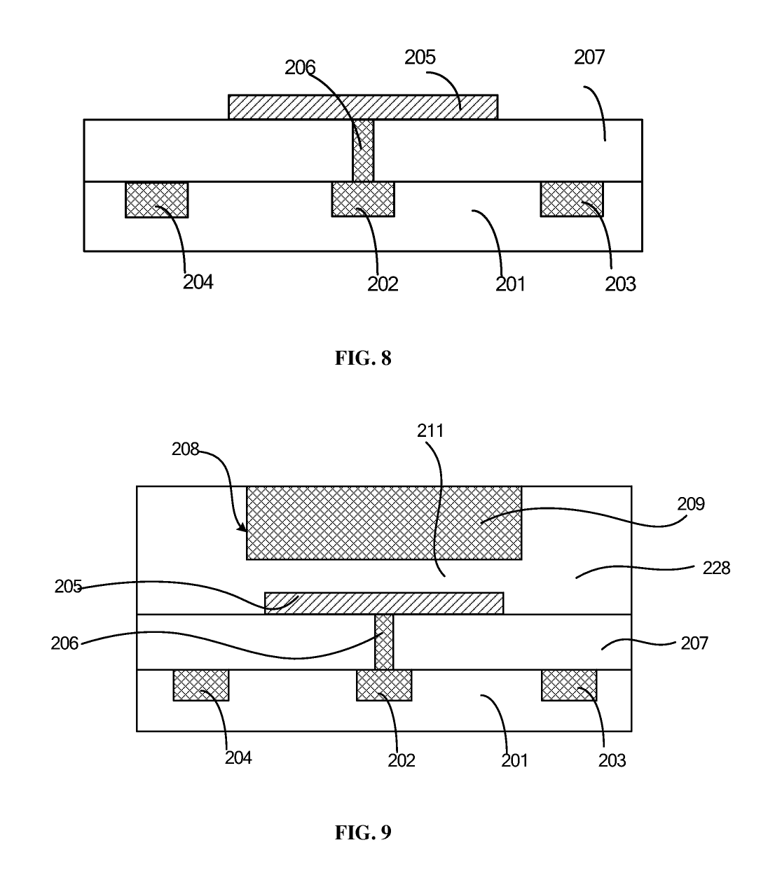

Referring to FIG. 8, a first dielectric layer 207 is formed on the substrate 201. A bottom electrode 205 is formed on the first dielectric layer 207. A first conducting plug 206 is formed below the bottom electrode 205, and the first conducting plug 206 is electrically connected with the bottom electrode 205 and the first control end 202. The first dielectric layer 207 includes one selected from silicon oxide, silicon oxide nitride, silicon carbide and silicon nitride, or a combination thereof. The bottom electrode 205 includes metal which may be one selected from silver, aluminum, copper, titanium, platinum, gold, nickel and cobalt, or a combination thereof.

Referring to FIG. 9, a second dielectric layer 228 is formed on the first dielectric layer 207. The second dielectric layer 228 includes a bottom insulating layer 211. The second dielectric layer 228 may include one selected from silicon oxide, silicon oxide nitride, silicon carbide, and silicon nitride, or a combination thereof. The bottom insulating layer 211 is in the second dielectric layer 228 above the bottom electrode 205 and adapted for electrically insulating the bottom electrode 205 from a movable electrode formed in subsequent steps. The bottom insulating layer 211 may include one selected from silicon oxide, silicon oxide nitride, silicon carbide, and silicon nitride, or a combination thereof. In a preferable embodiment, the bottom insulating layer 211 include a same material with the second dielectric layer 228, so that they can be formed at a same process and manufacturing steps can be reduced. In other embodiments the bottom insulating layer 211 may be formed in an additional step and include one selected from silicon oxide, silicon oxide nitride, silicon carbide, and silicon nitride, or a combination thereof.

Referring to FIG. 9, the second dielectric layer 228 is etched to form a first opening 208 therein, until the bottom insulating layer 211 is exposed. A location of the first opening 208 corresponds to a location of the bottom electrode 205, where a first part of a cavity will be formed in subsequent steps, so that the movable electrode can move therein.

Referring to FIG. 9, a first sacrificial layer 209 is filled in the first opening 208 and the first sacrificial layer 209 covers the bottom insulating layer 211.

The first sacrificial layer 209 is adapted for supporting the movable electrode while the movable electrode is formed in subsequent steps and will be removed at last. So the first sacrificial layer 209 includes a material which can be easily removed. Namely, there is a high etching selectivity ratio between the first sacrificial layer 209 and the second dielectric layer 228 or the movable electrode, which can ensure no damage is caused to other elements while removing the first sacrificial layer 209. For example, the first sacrificial layer 209 may include carbon, germanium, or polyamide. In an embodiment, the first sacrificial layer 209 includes amorphous carbon and is formed by a plasma enhanced chemical vapor deposition process (PECVD). For ensuring a good quality of the formed amorphous carbon film, a temperature in the PECVD is about 350° C. to 450° C.

The PECVD for filling the amorphous carbon in the first opening 208 is compatible with the CMOS process, and the formed amorphous carbon film has a dense structure and can be oxidized to be carbon dioxide by an ash process and removed by gasification easily, which brings no influence to other elements. It should be noted that after filling the first sacrificial layer 209 in the first opening 208 by using PECVD, a planarization process is performed to ensure metal can be evenly deposited while forming the movable electrode in a subsequent step.

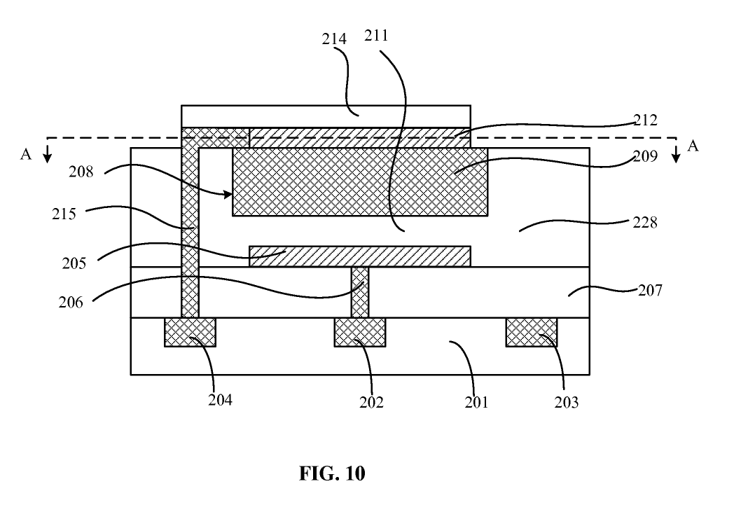

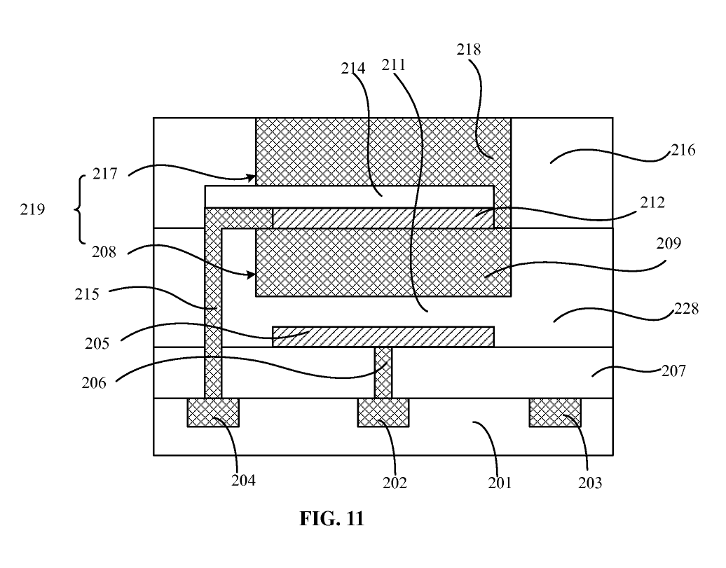

Referring to FIG. 10, a movable electrode 212 is formed on the second dielectric layer 228 and the first sacrificial layer 209. The movable electrode 212 is electrically insulated from the bottom electrode 205, and is electrically connected with the second control end 204 through a second conducting plug 215. A location of the movable electrode 212 corresponds to that of the bottom electrode 205. Before forming the movable electrode 212, the second conducting plug 215 is formed in a location corresponding to locations of the second control end 204 and the movable electrode 212. The second conducting plug 215 is symmetrically disposed with respect to the center of the movable electrode 212 and passes through the second dielectric layer 228 and the first dielectric layer 207. A surface of the movable electrode 212 far away from the bottom electrode 205 is a reflecting surface, adapted for reflecting lights.

Referring to FIG. 15, a sectional view of FIG. 10 along an AA direction. The first opening 208 is formed in the second dielectric layer 228 and filled with the first sacrificial layer 209. The movable electrode 212 is electrically connected with the second control end 204 through the second conducting plug 215. The second conducting plug 215 is symmetrically disposed with respect to the center of the movable electrode 212. The second conducting plug 215 is not only adapted for electrically connecting the movable electrode 212 with the second control end 204, but also is adapted for supporting the movable electrode 212 so that the movable electrode 211 suspends and moves in the cavity. The movable electrode 212 shifts under influence of an electrostatic force provided by the control circuit, and the movable electrode 212 can be kept in balance while shifting because The second conducting plug 215 is symmetrically disposed with respect to the center of the movable electrode 212. On a premise that the movable electrode 212 can be kept in balance under the influence of the electrostatic force, there may be three or more second conducting plugs 215, which may be determined according to practical requirements and is not described in detail herein.

In an embodiment, the first opening 208 and a part of the movable electrode in the first opening 208 are quadrate. In other embodiments, the first opening 208 and the part of the movable electrode in the first opening 208 may have other shapes, such as circular shape, and the like.

The movable electrode includes metal which may be one selected from silver, aluminum, copper, titanium, platinum, gold, nickel, and cobalt, or a combination thereof. A thickness of the movable electrode 212 is about 500 Å to about 10000 Å.

Referring to FIG. 10, the movable electrode includes a metal material. To avoid uneven thickness due to process limitations in manufacturing processes and metal fatigue due to frequent shifting of the movable electrode 212, a top insulating layer 214 is formed. The top insulating layer 214 includes a transparent insulating material with a specific resistance to bending fatigue, so that reflecting effect of the reflecting surface of the movable electrode 212 is not adversely influenced. The top insulating layer 214 is adapted for electrically insulating the movable electrode 212 from a top electrode formed in subsequent steps.

Referring to FIG. 11, a third dielectric layer 216 is formed above the second dielectric layer 228 and the movable electrode 212, and a second opening 217 is formed in the third dielectric layer 216. The second opening 217 has a location corresponding to the first opening 208 and is adapted for forming a second part of the cavity in subsequent steps.

Thereafter, a second sacrificial layer 218, which is adapted for supporting a top electrode formed in subsequent steps, is filled in the second opening 217. The second sacrificial layer 218 and the first sacrificial layer 209 in the first opening will be removed so that the first opening 208 and the second opening 217 constitute the cavity. The second sacrificial layer 218 also includes a material which can be easily removed. Namely, there is a high etching selectivity ratio between the second sacrificial layer 218 and the third dielectric layer 216 or the movable electrode, which can ensure no damage is caused to other elements while removing the second sacrificial layer 218. For example, the second sacrificial layer 218 may include carbon, germanium, or polyamide. In an embodiment, the first and second sacrificial layers 209 and 218 have a same material and a same manufacturing method, and both of them may be removed in a same process.

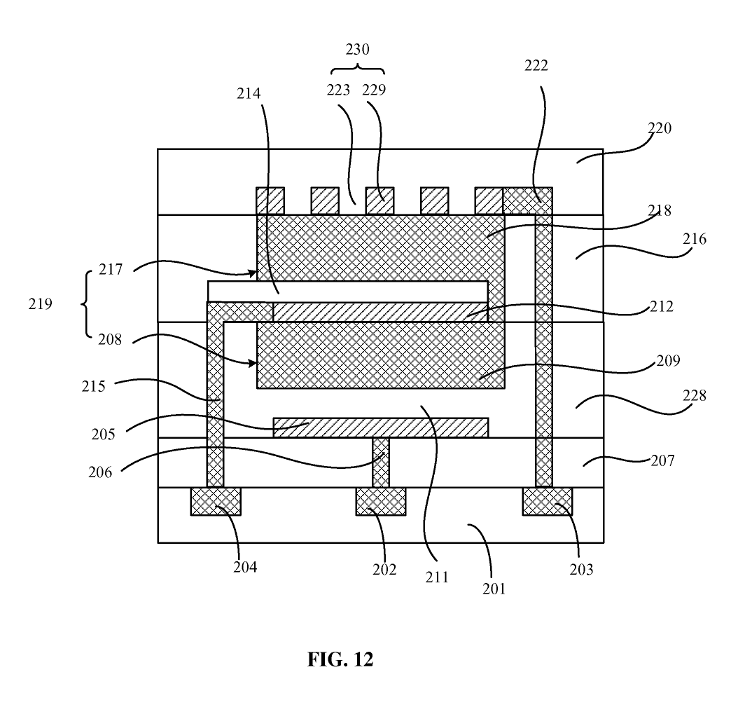

Referring to FIG. 12, a fourth dielectric layer 220 is formed on the third dielectric layer 216, and a top electrode 230, which is above the second opening 217, is formed in the fourth dielectric layer 220.

The fourth dielectric layer 220 may include one selected from silicon oxide, silicon oxide nitride, silicon carbide, and silicon nitride, or a combination thereof.

A structure of the top electrode 230 is shown FIG. 3. The top electrode 230 is a grating, including at least two grating bars 229 and grating openings 223 between two adjacent grating openings 229. The grating openings 223 are filled with a transparent insulating material which may be one selected from silicon oxide, silicon oxide nitride, silicon carbide, and silicon nitride, or a combination thereof.

The grating openings 229 includes metal which may be one selected from silver, aluminum, copper, titanium, platinum, gold, nickel, and cobalt, or a combination thereof. A thickness of the movable electrode 212 is about 500 Å to about 10000 Å. Surfaces of the grating bars 229 far away from the movable electrode 212 are reflecting surfaces. In a preferable embodiment, the grating bars 229 and the movable electrode 212 include a same material so that the reflecting surfaces of them have a same reflectivity. In a preferable embodiment, the grating bars 229 and grating opening 223 have a same width so that incident lights coming into the light modulator pixel unit can be equally separated into a first part and a second part. The first part is reflected by the grating bars 229, and the second part passes through the grating openings 229 and arrives at the reflecting surface of the movable electrode 212. The width of the grating bars 229 is a distance between one side and the other side of the grating bar, and the width of the grating openings 229 is a distance from one side of a grating bar to a side of an adjacent grating bar. In FIG. 12, there are 5 grating bars 229. In practical operation, the number of the grating bars 229 can be determined according to practical requirements.

The grating bars 229 of the top electrode 230 are electrically connected with the third control end 203 through a third conducting plug 222. So before forming the fourth dielectric layer 220 and the top electrode 230, the third conducting plug 222 is formed and the manufacturing method for forming the third conducting plug is the same as that in the prior art, which is not described in detail herein.

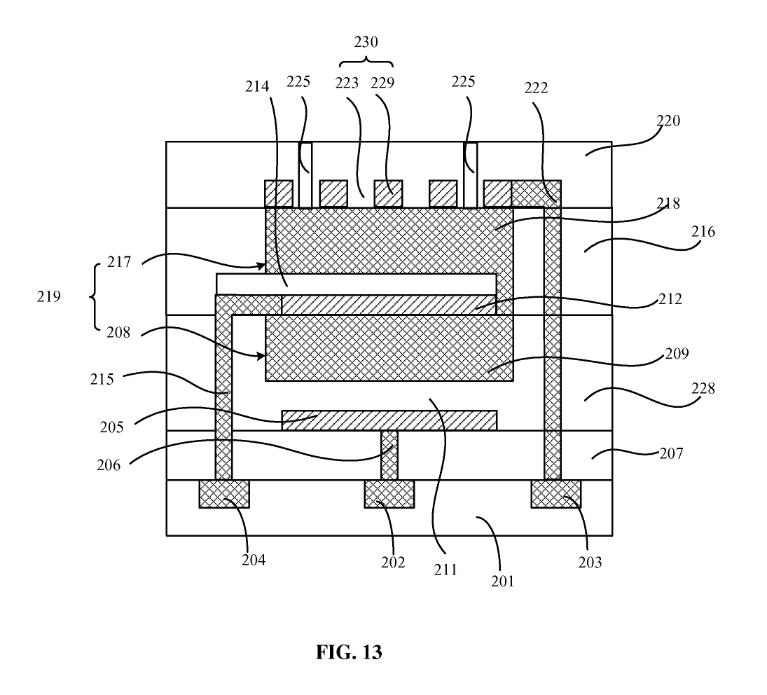

Referring FIG. 13, the fourth dielectric layer 220 is etched to form vias 225 until the second sacrificial layer 217 is exposed. The vias 225 are located in the gratings opening 223, and are adapted for injecting a gas or liquid to remove the first and second sacrificial layers 209 and 218. To avoid a difficult sealing of the vias 225 by a deposition process, the aspect ratio of the vias 225 should not be too great. To avoid adverse influence on the removal of the first and second sacrificial layers 209 and 218, the aspect ratio of the vias 225 also should not be too small. The aspect ratio of the vias 225 can be selected according to the materials and thicknesses of the first and second sacrificial layers 209 and 218, and those skilled in the art can freely adjust it based on the above principle and obtain an optimized scope after a number of experiments. In an embodiment, of the aspect ratio of the vias 225 is about 0.3 to about 5. Taking the first and second sacrificial layers 209 and 218 including amorphous carbon as an example, the first and second sacrificial layers 209 and 218 are removed by an ash process (a kind of dry etching process). Specifically, at a high temperature (about 100 to about 350° C.), oxide ions pass through the vias 225, bombard the amorphous carbon and oxidize the amorphous carbon to be a gaseous oxide, thereby removing the first and second sacrificial layer 209 and 218, without damaging other elements.

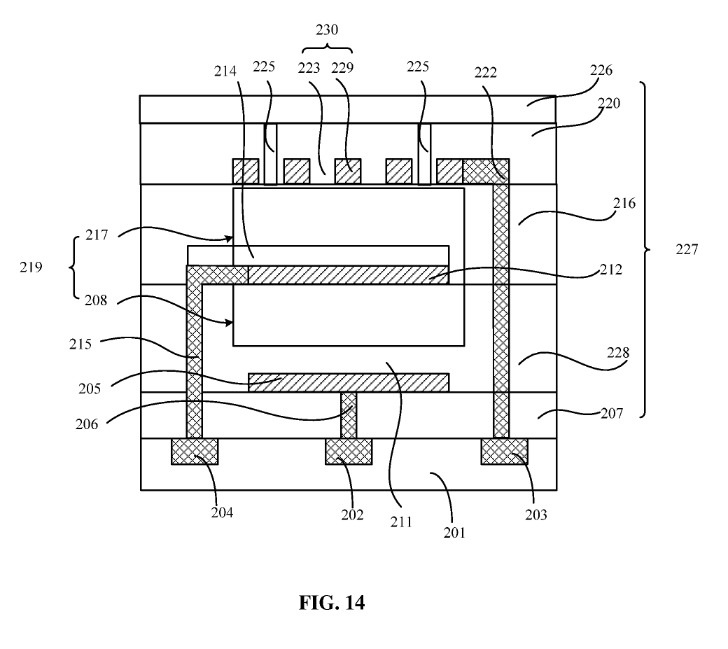

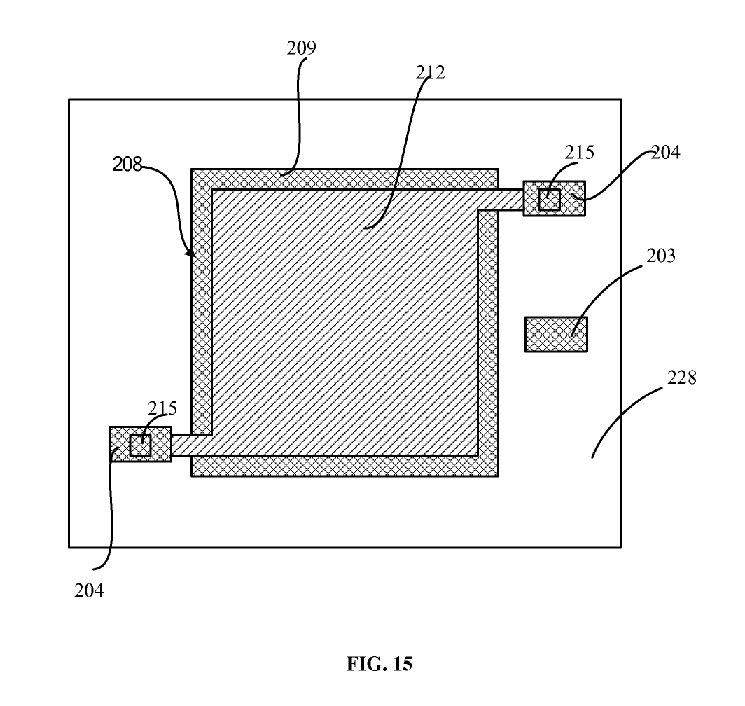

Referring to FIG. 14, the first sacrificial layer in the first opening 208 (not shown in the drawing) and the second sacrificial layer in the second opening 217 (not shown in the drawing) are removed, a covering layer 226, which covers and seals the vias (not shown in the drawing), is formed on the fourth sacrificial layer. After the first sacrificial layer in the first opening 208 (not shown in the drawing) and the second sacrificial layer in the second opening 217 (not shown in the drawing) are removed, the first opening 208 and the second opening 217 constitute a cavity 219, where the first opening 208 is a first part of the cavity 219, and the second opening 217 is a second part of the cavity 219. The movable electrode 212 is located in the cavity 219.

The covering layer 226 is adapted for sealing the vias off, including one selected from silicon oxide, silicon nitride and silicon oxide nitride, or a combination thereof. In a preferable embodiment, the covering layer 226, and the first, second, third, and fourth dielectric layers 207, 228, 216, and 220 have a same material and constitute an interlayer dielectric layer 227, which are adapted for insulating the electrodes from the conducting plugs.

In conclusion, a light modulator pixel unit and a manufacturing method thereof are provided in embodiments of the present disclosure. The light modulator pixel unit can perform time-sharing modulation to lights in three primary colors within a specific wavelength scope to realize color pixel and gray scale control, which is suitable for a micro display system and a panel display system.

Although the present disclosure has been disclosed as above with reference to preferred embodiments, it is not intended to limit the present disclosure. Those skilled in the art may modify and vary the embodiments without departing from the spirit and scope of the present disclosure. Accordingly, the scope of the present disclosure shall be defined in the appended claim.

What is claimed is:

1. A light modulator pixel unit, comprising:
a substrate;
a bottom electrode, wherein the bottom electrode is electrically connected with a first control end of a control circuit;
a top electrode formed on the substrate, wherein the top electrode is electrically connected with a third control end of the control circuit, the top electrode is a grating comprising at least two grating bars and grating openings between each two adjacent grating bars, and surfaces of the grating bars far away from a top surface of the bottom electrode are reflecting surfaces; and
a movable electrode, located between the bottom electrode and the top electrode, wherein the movable electrode is electrically connected with a second control end of the control circuit, a surface of the movable electrode facing the top electrode is a reflecting surface, the movable electrode can move along a direction perpendicular to the reflecting surface, and an electrical insulating material is filled between the movable electrode and the top electrode and between the movable electrode and the bottom electrode,
wherein there is a positional correspondence among the movable electrode, the top electrode, and the bottom electrode, an area of the movable electrode is less than that of the top electrode,
wherein under control of the control circuit, the movable electrode shifts to first, second and third positions, if the movable electrode shifts to the first position, a first light incident in the light modulator pixel unit passes through the grating openings of the top electrode, and is reflected by the movable electrode and diffracted on the top electrode; if the movable electrode shifts to the second position, a second light incident in the light modulator pixel unit passes through the grating openings of the top electrode, and is reflected by the movable electrode and diffracted on the top electrode; if the movable electrode shifts to the third position, a third light incident in the light modulator pixel unit passes through the grating openings of the top electrode, and is reflected by the movable electrode and diffracted on the top electrode, and the first, second and third lights are lights in three primary colors, and
wherein the grating bars and the grating openings have a same width ranging from about 0.1 μm to about 5 μm.

2. The light modulator pixel unit according to claim 1, wherein the control circuit is located in the substrate, or formed in another substrate.

3. The light modulator pixel unit according to claim 1, wherein the bottom and top electrode are electrically insulated from the substrate.

4. The light modulator pixel unit according to claim 1, further comprising: an interlayer dielectric layer, located on the substrate; and
a cavity, located in the interlayer dielectric layer, wherein the cavity has walls, the cavity is separated into a first part and a second part, the first part is a lower part of the cavity, and the second part is an upper part of the cavity,
wherein the bottom electrode is located in a part of the interlayer dielectric layer which is between the first part and the substrate, the top electrode is located in another part of the interlayer dielectric layer which is between the second part and the substrate, the movable electrode is located in the cavity, there is an interval between the movable electrode and the walls of the cavity, and the movable electrode can move in the interval.

5. The light modulator pixel unit according to claim 1, wherein the electrical insulating material filled between the movable electrode and the top electrode and the electrical-insulating material filled between the movable electrode and the bottom electrode are the interlayer dielectric layer or formed by an additional process.

6. The light modulator pixel unit according to claim 5, wherein the interlayer dielectric layer or the electrical insulating material formed by an additional process comprises one selected from silicon oxide, silicon oxide nitride, silicon carbide, and silicon nitride, or a combination thereof.

7. The light modulator pixel unit according to claim 4, wherein a plurality of second conducting plugs are formed in the interlayer dielectric layer and electrically connects the second control end with the movable electrode, wherein a distribution of the plurality of second conducting plugs is symmetrical and centered in a center of the movable electrode.

8. The light modulator pixel unit according to claim 1, wherein the top electrode comprises metal and have a thickness ranging from about 500 Å to about 10000 Å, wherein the metal comprises one selected from silver, aluminum, copper, titanium, platinum, gold, nickel, and cobalt, or a combination thereof.

9. The light modulator pixel unit according to claim 1, wherein the movable electrode comprises metal and have a thickness ranging from about 500 Å to about 10000 Å, wherein the metal comprises one selected from silver, aluminum, copper, titanium, platinum, gold, nickel, and cobalt, or a combination thereof.

10. The light modulator pixel unit according to claim 1, wherein the grating bar and the movable electrode have a same material.

11. A method for manufacturing an light modulator pixel unit, comprising:
providing a substrate;
forming a bottom electrode on the substrate, wherein the bottom electrode is electrically connected with a first control end of a control circuit;
forming a top electrode on the substrate, wherein the top electrode is electrically connected with a third control end of the control circuit, the top electrode is a grating comprising at least two grating bars and at least one grating opening between each two adjacent grating bars, and surfaces of the grating bars far away from the bottom electrode are reflecting surfaces; and
forming movable electrode. Wherein the movable electrode is located between the bottom electrode and the top electrode, the movable electrode is electrically connected with a second control end of the control circuit, there is an electrical insulating materials formed between the movable electrode and the top electrode or between the movable electrode and the bottom electrode, a surface of the movable electrode facing the top electrode is a reflecting surface,
wherein the movable electrode shifts to a first, second and third position, along a direction perpendicular to the reflecting surface: if the movable electrode shifts to the first position, a first light incident in the light modulator pixel unit passes through the grating openings of the top electrode, and is reflected by the movable electrode and diffracted on the top electrode; if the movable electrode shifts to the second position, a second light incident in the light modulator pixel unit passes through the grating openings of the top electrode, and is reflected by the movable electrode and diffracted on the top electrode; if the movable electrode shifts to the third position, a third light incident in the light modulator pixel unit passes through the grating openings of the top electrode, and is reflected by the movable electrode and diffracted on the top electrode, and the first, second and third lights are lights in three primary colors, and the grating bars and the grating openings have a same width.

12. The method according to claim 11, wherein the control circuit is located in the substrate, or formed in another substrate.

13. The method according to claim 11, wherein the bottom and top electrode are electrically insulated from the substrate.

14. The method according to claim 11, further comprising:
forming an interlayer dielectric layer;
forming a cavity in the interlayer dielectric layer, wherein the cavity comprises walls, the cavity comprises a first part and second part, the first part is located in lower part of the cavity, and the second part is located in upper part of the cavity, the bottom electrode is in a part of the interlayer dielectric layer which is between the first part and the substrate, the top electrode is another part of the interlayer dielectric layer which is between the second part and the substrate. The movable electrode is in the cavity, there are an interval between the movable electrode and the walls of the cavity, and the movable electrode can move in the interval.

15. The method according to claim 11, wherein the electrical insulating material filled between the movable electrode and the top electrode and the electrical insulating material filled between the movable electrode and the bottom electrode are the interlayer dielectric layer or formed by an additional process.

16. The method according to claim 11, wherein a plurality of second conducting plugs are formed in the interlayer dielectric layer and electrically connect the second control end with the movable electrode, wherein the multiple second conducting plugs are symmetrically distributed with respect to the center of the movable electrode.

17. The method according to claim 11, wherein the grating bar and the movable electrode have a same material.
